(19) United States
(12) Patent Application Publication
(10) Pub. No.: US 2025/0375782 A1
(43) Pub. Date: Dec. 11, 2025

(54) AIR CAP FOR A FLUID SPRAY GUN

(71) Applicant: Graco Minnesota Inc., Minneapolis, MN (US)

(72) Inventor: Christopher C. Wagner, Saint Anthony, MN (US)

(21) Appl. No.: 19/196,134

(22) Filed: May 1, 2025

Related U.S. Application Data
(60) Provisional application No. 63/656,401, filed on Jun. 5, 2024.
(60) Provisional application No. 63/673,908, filed on Jul. 22, 2024.

(51) Int. Cl. B05B 7/04; B05B 7/12

(52) U.S. Cl. CPC B05B 7/0475; B05B 7/12

(57) ABSTRACT

A spray gun is configured to emit spray fluid and compressed air that impinges on the spray fluid to atomize the spray fluid. An air cap is configured to emit the compressed air. The air cap includes prongs that extend axially away from a fluid spray nozzle. Openings are formed through the prongs and are configured to emit compressed gas onto the fluid output to shape the fluid output. The openings are disposed in a stacked configuration and include openings offset from a spray axis.

### CROSS-REFERENCE TO RELATED APPLICATION(S)

This application claims the benefit of U.S. Provisional Application No. 63/656,401 filed Jun. 5, 2024 and entitled “AIR CAP FOR A FLUID SPRAY GUN,” and claims the benefit of U.S. Provisional Application No. 63/673,908 filed Jul. 22, 2024 and entitled “AIR CAP FOR A FLUID SPRAY GUN,” the disclosures of which are hereby incorporated by reference in their entireties.

### BACKGROUND

This disclosure relates to sprayers. More specifically, this disclosure relates to air caps for sprayers.

Spray guns can be used to spray fluids on surfaces. For example, spray guns can be used to spray paint, lacquer, finishes, dielectric material, and other coatings on furniture, cabinets, appliances, equipment, fabricated components, etc.

Typically, the spray fluid is placed under pressure by a piston, diaphragm, or other positive displacement pump. Spray guns can be configured as air sprayers in which compressed gas emitted from the spray gun atomizes and shapes the fluid output. Such air sprayers can be configured as low pressure sprayers, at which the spray fluid is provided at pressures up to 500 pounds per square inch (psi). The pump outputs the spray fluid under pressure through a flexible hose. A spray gun is used to dispense the spray fluid, the gun being attached to the end of the hose opposite the pump. In this way, the spray gun does not include a pump, but rather releases spray fluid pumped to the spray gun through the hose. The spray gun atomizes the spray fluid under pressure into a spray fan, which is applied to a surface.

Some spray guns, which can be referred to as air sprayers, emit airflows atomize and shape the fluid spray. Such spray guns emit fluid through a spray nozzle and emit the airflows proximate the fluid spray. Such spray guns include valves to control the fluid flow and the one or more airflows. Such spray guns do not include a nozzle that hydraulically atomizes the spray fluid, unlike air-assisted airless or airless sprayers.

### SUMMARY

According to an aspect of the disclosure, an air cap for a spray gun is configured to output compressed gas onto a spray fluid, the air cap including a cap body having a central aperture therethrough, the central aperture disposed on a body axis of the cap body, the cap body further including a plurality of prongs extending from an outer side of the cap body; a plurality of face ports formed through the outer side; a first set of fan ports formed through an inner exterior side of a first prong of the plurality of prongs; and a second set of fan ports formed through an inner exterior side of a second prong of the plurality of prongs. The first set of fan ports includes a first inner fan port; and a first plurality of outer fan ports, the first plurality of outer fan ports disposed axially closer to a distal end of the first prong than the first inner fan port. The second set of fan ports includes a second inner fan port; and a second plurality of outer fan ports, the second plurality of outer fan ports disposed axially closer to a distal end of the second prong than the second inner fan port.

According to an additional or alternative aspect of the disclosure, an air cap for a spray gun is configured to output compressed gas onto a spray fluid, the air cap includes a cap body having a central aperture therethrough, the central aperture disposed on a body axis of the cap body, the cap body further including a plurality of prongs extending from an outer side of the cap body; a plurality of face ports formed through the outer side; a first set of fan ports formed through an inner exterior side of a first prong of the plurality of prongs; and a second set of fan ports formed through an inner exterior side of a second prong of the plurality of prongs. The first set of fan ports includes a first inner fan port; and a first outer fan port disposed axially closer to a distal end of the first prong than the first inner fan port, the first outer fan port circumferentially offset from the first inner fan port; and a second outer fan port disposed axially closer to the distal end of the first prong than the first inner fan port, the second outer fan port circumferentially offset from the first inner fan port. The second set of fan ports includes a second inner fan port; a third outer fan port disposed axially closer to a distal end of the second prong than the second inner fan port, the third outer fan port circumferentially offset from the second inner fan port; and a fourth outer fan port disposed axially closer to the distal end of the second prong than the second inner fan port, the fourth outer fan port circumferentially offset from the second inner fan port.

According to another additional or alternative aspect of the disclosure, spray gun includes a gun body; a nozzle formed in a nozzle body, the nozzle body at least partially disposed within the gun body, the nozzle configured to output spray fluid along a spray axis; a valve configured to control flow of the spray fluid through the nozzle; and an air cap mounted to the gun body. The air cap includes a cap body having a central aperture therethrough, the central aperture disposed on a body axis of the cap body, the cap body further including a plurality of prongs extending from an outer side of the cap body, wherein the nozzle body extends into the central aperture; a plurality of face ports formed through the outer side; a first set of fan ports formed through an inner exterior side of a first prong of the plurality of prongs; and a second set of fan ports formed through an inner exterior side of a second prong of the plurality of prongs. The first set of fan ports includes a first inner fan port; a first outer fan port disposed axially closer to a distal end of the first prong than the first inner fan port, the first outer fan port circumferentially offset from the first inner fan port; and a second outer fan port disposed axially closer to the distal end of the first prong than the first inner fan port, the second outer fan port circumferentially offset from the first inner fan port. The second set of fan ports includes a second inner fan port; a third outer fan port disposed axially closer to a distal end of the second prong than the second inner fan port, the third outer fan port circumferentially offset from the second inner fan port; and a fourth outer fan port disposed axially closer to the distal end of the second prong than the second inner fan port, the fourth outer fan port circumferentially offset from the second inner fan port. The air cap is configured to output an atomizing compressed gas flow through an atomization opening disposed between the nozzle body and a portion of the cap body defining the central aperture. The air cap is configured to output a shaping compressed gas flow through the first set of fan port and the second set of fan ports.

According to yet another additional or alternative aspect of the disclosure, a method of shaping a coating liquid during spraying includes outputting the coating liquid through nozzle as a stream and along a spray axis; and outputting a first portion of compressed gas through an atomization opening in an air cap, the atomization opening disposed annularly about the spray axis, to atomize the stream into a fluid spray: outputting a second portion of the compressed gas through a plurality of fan ports formed in a first prong and a second prong of the air cap to shape the fluid spray, by: outputting the second portion through a first inner fan port of the plurality of fan ports and towards a first focal point, the first inner fan port formed on the first prong; outputting the second portion through a first outer fan port of the plurality of fan ports and towards the fluid spray, the first outer fan port formed on the first prong and disposed axially further from the nozzle than the first inner fan port, and the first outer fan port circumferentially offset from the first inner fan port; outputting the second portion through a second outer fan port of the plurality of fan ports and towards the fluid spray, the second outer fan port formed on the first prong and disposed axially further from the nozzle than the first inner fan port, and the second outer fan port circumferentially offset from the first inner fan port; outputting the second portion through a second inner fan port of the plurality of fan ports and towards the first focal point, the second inner fan port formed on the second prong; outputting the second portion through a third outer fan port of the plurality of fan ports and towards the fluid spray, the third outer fan port formed on the second prong and disposed axially further from the nozzle than the second inner fan port, and the third outer fan port circumferentially offset from the second inner fan port; and outputting the second portion through a fourth outer fan port of the plurality of fan ports and towards the fluid spray, the fourth outer fan port formed on the second prong and disposed axially further from the nozzle than the second inner fan port, and the fourth outer fan port circumferentially offset from the second inner fan port.

### BRIEF DESCRIPTION OF THE DRAWINGS

FIG. 1 is a schematic block diagram of a sprayer.

FIG. 2 is an isometric view of a sprayer.

FIG. 3 is an isometric view of a sprayer.

FIG. 4 is an enlarged cross-sectional view of an output end of a sprayer.

FIG. 5A is a first isometric view of an air cap.

FIG. 5B is a second isometric view of an air cap.

FIG. 6A is a cross-sectional view taken along line A-A in FIG. 5A.

FIG. 6B is a cross-sectional view taken along line B-B in FIG. 5A.

FIG. 7 is a front elevational view of an air cap.

FIG. 8 is a side view of an air cap showing a spray pattern.

FIG. 9 is a top view of an air cap showing shaping air outputs.

### DETAILED DESCRIPTION

This disclosure relates to fluid spraying. More specifically, this disclosure relates to air spraying. An air sprayer is configured to emit a spray of spray fluid, such as paints, varnishes, lacquers, fine finishes, high-gloss finishes, waterborne coatings, solvent-borne coatings, dielectric material, etc. The air sprayer can be used to apply coatings to surfaces, furniture, cabinets, appliances, equipment, fabricated components, electronics, etc. The air sprayer also emits compressed air. One portion of the compressed air is configured to assist with atomization and can blow spray fluid away from the nozzle to keep the air cap and sprayer clean. Another portion of the compressed air is configured to assist in atomization of the spray fluid and shape the spray pattern. The spray fluid is emitted through a nozzle and the air is emitted through an air cap. The spray gun is configured to spray at fluid pressures up to up to about 3.48 megapascal (MPa) (about 500 pounds per square inch (psi)). In some examples, the spray gun is configured to spray at fluid pressures up to about 2.07 MPa (about 300 psi).

The sprayer includes a valve that controls emission of the spray fluid through a spray nozzle. The spray fluid is emitted as a stream that is impacted by compressed gas. The compressed gas atomizes and shapes the spray fluid into a desired spray pattern. An air cap is configured to emit both atomization and shaping air to atomize the spray fluid and shape the atomized spray fluid into a desired spray pattern. The air cap includes an atomization opening through which atomization air is emitted. In some examples, the atomization opening is disposed coaxially with the spray axis along which the spray fluid is output. The air cap includes shaping openings through which the shaping air is emitted. The shaping openings are formed on air horns that project axially away from the spray nozzle. The shaping openings direct the shaping air to impinge on the spray fluid to shape the spray fluid into the spray pattern.

The shaping openings are disposed along each air horn. The shaping openings include inner openings and outer openings. The inner openings are disposed axially closer to the atomization opening than the outer openings. The air cap can include a plurality of outer openings on each air horn. The outer openings can be offset from the inner opening. The outer openings can be radially offset from the inner opening.

In some examples, air caps according to the disclosure are configured such that the inner openings of opposing air horns are opposed from each other. Such inner openings can be oriented to have their outflows aimed at a common intersect location. In some examples, air caps according to the disclosure are configured such that the outer openings of opposing air horns are opposed from each other. For example, an outer opening on a first air horn can be directly across from an outer opening on a second air horn. The opposed outer openings can be oriented to have their outflows aimed at a common intersect location.

Air caps according to some aspects of the disclosure can include multiple opposed pairs of outer openings. For example, each air horn can include two outer openings with opposed pairs including one outer opening from each air horn. The outer openings within an opposed pair can be oriented to have their outflows aimed at a common intersect location. In additional or alternative examples, each opposed pair can be configured to aim their outflows at different intersect locations from others of the opposed pairs.

Air caps according to the disclosure can atomize greater volumes of spray material as compared to prior air caps. The air caps can, in some examples, atomize and shape up to twice as much spray material per unit time as prior air caps. The air caps can generate wider spray patterns while sufficiently atomizing the spray material and without causing splitting or tailing. The air caps facilitate utilizing greater rates of spray material flow with the same compressed gas pressure while still providing desired atomization and shaping.

Components can be considered to radially overlap when those components are disposed at common axial locations along an axis. A radial line extending orthogonally from axis will extend through each of the radially overlapping components. Components can be considered to axially overlap when those components are disposed at common radial and circumferential locations relative to the axis. An axial line parallel to the axis will extend through the axially overlapping components. Components can be considered to circumferentially overlap when those components are disposed at common radial distance and axial locations along the axis, such that a circle centered on the axis passes through each of the circumferentially overlapping components.

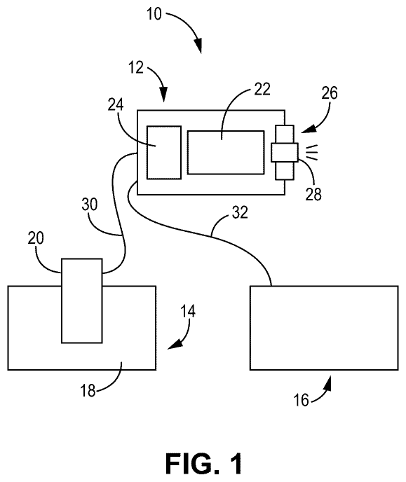

FIG. 1 is a block diagram of a spray system 10. Spray system 10 includes spray gun 12, fluid supply 14, and air supply 16. Fluid supply 14 includes reservoir 18 and pump 20. Spray gun 12 includes spray valve 22, actuator 24, air cap assembly 26, and nozzle 28.

Spray gun 12 is configured to emit a spray of spray fluid for application on a target surface. The spray fluid can be liquid, such as a coating liquid. For example, spray gun 12 can be used to spray paint, lacquer, finishes, and other coatings on furniture, cabinets, appliances, equipment, fabricated components, etc. Spray gun 12 can be configured to emit airflows to assist in atomizing and/or shaping the spray fluid emitted by spray gun 12. As such, spray gun 12 can be configured to emit one or more compressed gas flows along with the spray fluid. The compressed gas that atomizes the fluid spray can be referred to as “atomization air.” The compressed gas that shapes the spray pattern can be referred to as “shaping air” or “fan air.” Spray gun 12 emits the spray fluid through nozzle 28 and emits the airflows proximate the nozzle 28 and from air cap assembly 26. The airflows are configured to impinge on the emitted spray fluid to atomize and/or shape the spray fluid.

Fluid supply 14 is configured to supply spray fluid to spray gun 12 for spraying. Reservoir 18 is configured to store a supply of spray fluid. For example, reservoir 18 can be a tank, bucket, barrel, or other container suitable for storing a volume of the spray fluid. Pump 20 is configured to drive the spray fluid downstream from reservoir 18 to the spray gun 12 under pressure. Fluid hose 30 extends between and fluidly connects pump 20 and spray gun 12. The pump 20 can be of any type suitable for driving pressurized spray fluid to spray gun 12. For example, the pump 20 can be a piston pump, a diaphragm pump, a rotor-stator pump, a peristaltic pump, a plunger pump, among other options.

Air supply 16 is configured to store and/or generate a supply of compressed air for use by spray gun 12. Air supply 16 is fluidly connected to the spray gun 12 by air hose 32 extending between air supply 16 and spray gun 12. Air supply 16 can be of any configuration suitable for storing and/or generating and supplying compressed air to the spray gun 12. For example, air supply 16 can be an air compressor, one or more pressurized tanks, etc. Air supply 16 can provide a single flow of compressed air to spray gun 12 and spray gun 12 can divide the compressed air to the atomization air and shaping air within spray gun 12. While spray gun 12 is described as utilizing compressed air, such as compressed atmospheric air, it is understood that any desired compressed gas suitable for spray operations can be used, such as compressed nitrogen gas among other options.

Spray valve 22 is configured to control flow of the spray fluid to nozzle 28. Spray valve 22 is disposed within spray gun 12. Spray valve 22 is disposed upstream of nozzle 28. Spray valve 22 is actuatable between an open state, in which the spray fluid can flow through the spray valve 22 and to and though nozzle 28 for atomization, and a closed state, in which the spray fluid is prevented from flowing through the spray valve 22 and to the nozzle 28. The spray valve 22 can be of any type suitable for controlling flow of the spray fluid. For example, the spray valve 22 can be a needle valve, among other options.

Spray valve 22 is operatively connected to actuator 24. Actuator 24 is configured to actuate the spray valve 22 between open and closed states. Actuator 24 can be mechanically connected to a movable component of spray valve 22 to displace that movable component and actuate the spray valve 22 between the open and closed states. In some examples, the actuator 24 can include a first displacer configured to actuate the spray valve 22 from the closed state to the open state and the actuator 24 can include a second displacer configured to actuate the spray valve 22 from the open state to the closed state. For example, the first displacer can be a piston, such as a pneumatic piston, a trigger, etc., and the second displacer can be a spring, among other options.

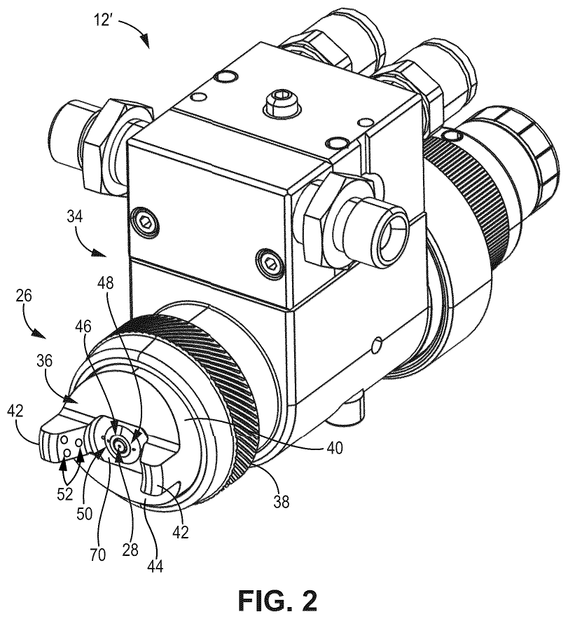

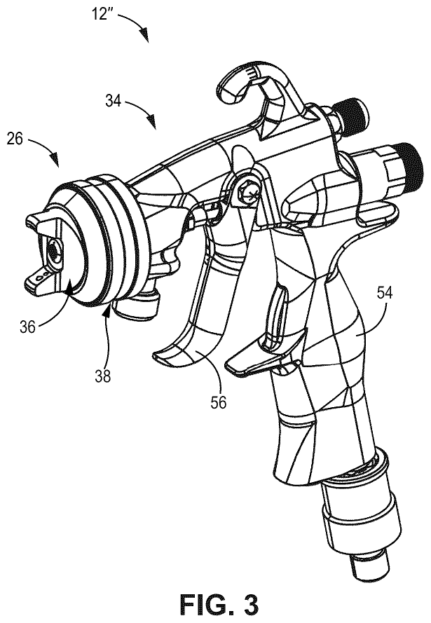

Spray gun 12 can be configured as an automatic spray gun (FIG. 2) or a manual spray gun (FIG. 3). In automatic spray gun examples, the spray gun 12 can be oriented and caused to spray by a controller (e.g., having a computer readable memory and control circuitry). The actuator 24 in such automatic spray gun examples can be pneumatically powered to actuate the spray valve 22. In some examples, the actuator 24 can be pneumatically displaced (e.g., by the compressed air from air supply 16) to shift the spray valve 22 to the open state and the actuator 24 can be mechanically displaced (e.g., by a spring) to shift the spray valve 22 to the closed state. In some examples, the compressed air from air supply 16 can cause the actuator 24 to displace the spray valve 22 both from the closed state to the open state and from the open state to the closed state. In manual spray gun examples, the actuator 24 can include a trigger that is depressed by the user. Depressing the trigger can cause the spray valve 22 to shift from the closed state to the open state. Releasing the trigger can cause the spray valve 22 to shift from the open state to the closed state. In some examples, actuating the trigger can direct compressed air to cause displacement of a piston, which piston is operatively connected to the spray valve 22 to displace the moving member of the spray valve 22. In some examples, the trigger mechanically actuates the spray valve 22 to an open state and spray gun 12 includes a spring that actuates the spray valve 22 from the open state to the closed state. In some manual gun examples, the actuator 24 can be pneumatically displaced to actuate the spray valve 22 to the open state and to actuate the spray valve 22 to the closed state.

FIG. 2 is an isometric view of spray gun 12′. Gun body 34 and air cap assembly 26 of spray gun 12′ are shown. Spray gun 12′ is an automatic spray version of spray gun 12.

Spray gun 12′ is configured to receive pressurized spray fluid and to output that spray fluid as an atomized fluid spray. Spray gun 12′ is configured to emit the spray fluid along spray axis SA. In the example shown, spray gun 12′ is an automatic spray gun. Gun body 34 supports other components of spray gun 12′.

Air cap assembly 26 is disposed at a first axial end of gun body 34. Air cap assembly 26 is supported by gun body 34. Air cap assembly 26 can be mounted directly to gun body 34, such as by a threaded interface among other options. Air cap assembly 26 is configured to direct compressed air flows for atomizing and, in some examples, shaping of the spray fluid output by spray gun 12′.

Air cap assembly 26 is disposed at a first axial end of gun body 34. Air cap 36 is configured to receive flows of compressed gas and to emit those flows of compressed gas towards the spray fluid output by spray gun 12′. Air cap 36 is mounted to gun body 34 by cap retainer 38. Cap retainer 38 extends over air cap 36 and interfaces with gun body 34 to secure air cap 36 to gun body 34. Cap retainer 38 is connected to gun body 34 by a threaded interface in the example shown, though it is understood that other connection types are possible. Air cap 36 is configured to emit both atomizing air and shaping air.

Air cap 36 includes cap body 40 having air prongs 42 and outer side 44. Central aperture 46 is formed through air cap 36. Central aperture 46 can extend fully through cap body 40 such that central aperture 46 is open in both axial directions AD1, AD2 along spray axis SA. Central aperture 46 is disposed on spray axis SA. Central aperture 46 is configured to emit atomization air from air cap 36. In the example shown, a portion of the nozzle assembly of spray gun 12′ extends into the central aperture 46. The atomization air can be emitted from the gap formed between the nozzle assembly and air cap 36. Such a gap forms the atomization opening 48 through which the atomization air is emitted from air cap 36. In the example shown, the atomization opening 48 is formed as an annular ring, though it is understood that other configurations are possible.

Face ports 50 are open through outer side 44. Face ports 50 are disposed on cap face 70. Face ports 50 are arrayed around central aperture 46. In the example shown, face ports 50 are disposed in two ports sets on either side of central aperture 46. Face ports 50 on air cap 36 are for cleanliness. It is understood that air cap 36 can include more, fewer, larger, or smaller face ports 50 in the same or different positions.

Prongs 42 projects axially outward relative to outer side 44 of cap body 40. Prongs 42 project in axial direction AD1 away from central aperture 46. Fan ports 52 are formed through prongs 42. Fan ports 52 are spaced axially from central aperture 46 in a direction downstream AD1 from central aperture 46 along spray axis SA. In the example shown, each prong 42 includes a plurality of the fan ports 52. Inner fan ports 52a are disposed axially closer to central aperture 46. Outer fan ports 52b are disposed axially further form central aperture 46. Outer fan ports 52b are disposed closer to the distal end of the prong 42 than the inner fan port 52a of the same prong 42. Fan ports 52 are configured to emit shaping air from air cap 36.

FIG. 3 is an isometric view of spray gun 12″. Spray gun 12″ is substantively similar to spray gun 12′ and spray gun 12, but is a manual version of a spray gun. Spray gun 12″ is a manual spray gun configured to be held in the hand of a user and activated directly by the user to spray the spray fluid, while spray gun 12′ is an automatic spray gun that is operated by a controller directing compressed gas to open the spray valve.

Spray gun 12″ is configured as a manual spray gun that is held in a hand of the user and actuated between spray and non-spray states by the user. The user can grasp handle 54 to aim and manipulate spray gun 12″. The user can hold sprayer 12″ and actuate spray gun 12″ between the spray and non-spray states with a single hand of the user. The user can depress trigger 56 with the fingers of the hand that is grasping handle 54 to actuate spray gun 12″ between the spray and non-spray states. Trigger 56 controls actuation of the spray valve that controls flow of spray fluid and, in some examples, can control actuation of an air valve that controls flow of compressed gas, such as the shaping portion of the compressed gas, to air cap 36.

Spray gun 12″ is configured to receive flows of spray fluid and compressed air and to emit an atomized spray of the spray fluid for application on a target surface. Spray gun 12″ is configured as a manual spray gun, though it is understood that not all examples are so limited. Gun body 34 supports other components of spray gun 12″.

Handle 54 extends from a lower side of the gun body 34. An air inlet passage can be formed within and through handle 54 to provide compressed gas to spray gun 12″.

Air cap assembly 26 is disposed at a first axial end of gun body 34. Air cap 36 is configured to emit both atomizing air and shaping air. Air cap 36 is mounted to gun body 34 by cap retainer 38. Cap retainer 38 extends over air cap 36 and interfaces with gun body 34 to secure air cap 36 to gun body 34 in the example shown. Cap retainer 38 can be mounted to gun body 34 by a quick connect interface, a threaded connection, among other options.

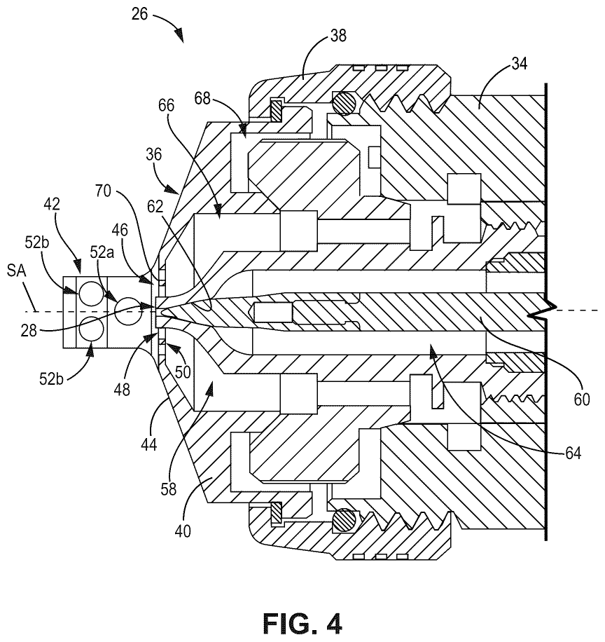

FIG. 4 is an enlarged cross-sectional view of a spray end portion of a sprayer. Air cap assembly 26 is mounted to the gun body 34 of a spray gun. Cap retainer 38 secures air cap 36 to spray gun 12.

Nozzle assembly 58 extends into air cap 36. Nozzle 28 is disposed at a distal end of nozzle assembly 58. Spray fluid is output through nozzle 28. In some examples, the spray fluid is output as a fluid stream. In some examples, the nozzle 28 is not shaped to atomize the spray fluid, instead the nozzle 28 can be formed as a circular opening, among other options.

Valve 22 is configured to control flow of spray fluid to and through nozzle 28. Valve 22 is configured to shift between an open state, allowing spray fluid to flow to and through nozzle 28, and a closed state, preventing spray fluid from flowing to nozzle 28. In the example shown, valve 22 is formed by needle 60 and seat 62. Needle 60 is configured to engage seat 62 to place valve 22 in the closed state. Needle 60 is spaced from seat 62 to place valve 22 in an open state. In the example shown, needle 60 is configured to shift axially along spray axis SA to place valve 22 in the respective states.

Fluid chamber 64 is disposed within nozzle assembly 58 in the example shown. Fluid chamber 64 is configured to receive spray fluid and can hold the spray fluid prior to spraying. Opening the valve 22 allows the pressurized spray fluid to flow from fluid chamber 64, past valve 22, and through nozzle 28 for emission from spray gun 12.

Atomization chamber 66 is at least partially defined by air cap 36. Atomization chamber 66 is in fluid communication with face ports 50 and atomization opening 48 to provide compressed gas to face ports 50 and atomization opening. Atomization chamber 66 is fluidly connected to passages within gun body 34 to receive compressed gas provided through gun body 34.

Shaping chamber 68 is at least partially defined by air cap 36. Shaping chamber 68 is in fluid communication with fan ports 52 to provide compressed gas to fan ports 52. Shaping chamber 68 is fluidly connected to passages within gun body 34 to receive compressed gas provided through gun body 34.

In the example shown, the atomization chamber 66 and shaping chamber 68 are fluidly isolated from each other. Such a configuration allows for discrete control of the atomization gas flow to air cap 36 and of the shaping gas flow to air cap 36. A pressure of the shaping gas flow can be adjusted to vary the width of the spray pattern output by the spray gun 12. The shaping gas flow and the atomization gas flow can be discretely and individually controlled to provide desired conditions for spraying.

As shown, atomization opening 48 is formed in central aperture 46. In the example shown, the atomization opening 48 is further defined by the body of nozzle assembly 58. The atomization opening 48 is formed as an annular ring in the example shown. The atomization opening 48 is configured to output compressed gas to atomize the stream of spray fluid output from the nozzle assembly 58. In the example shown, the sprayers do not include a shaping orifice configured to atomize the spray fluid. Instead, the spray fluid is output as a stream through nozzle 28 and the compressed gas output through atomization opening 48 performs an initial atomization of the spray fluid.

Fan ports 52 are configured to output compressed gas that impinges on the spray fluid to shape the spray fluid into a desired spray pattern. As shown, fan ports 52 are arrayed along the prong 42. An inner fan port 52a is axially closer to nozzle assembly 58 and outer fan ports 52b are axially further from nozzle assembly 58. The outer fan ports 52b are radially offset from the inner fan port 52a relative to the spray axis SA. The outer fan ports 52b are circumferentially offset from the inner fan port 52a. In the example shown, the outer fan ports 52b are disposed on opposite circumferentially sides of the inner fan port 52a. Air cap 36 includes a greater number of outer fan ports 52b than inner fan ports 52a on each prong 42.

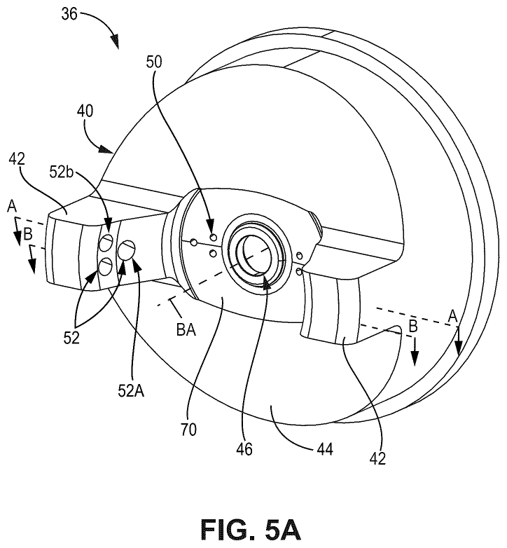

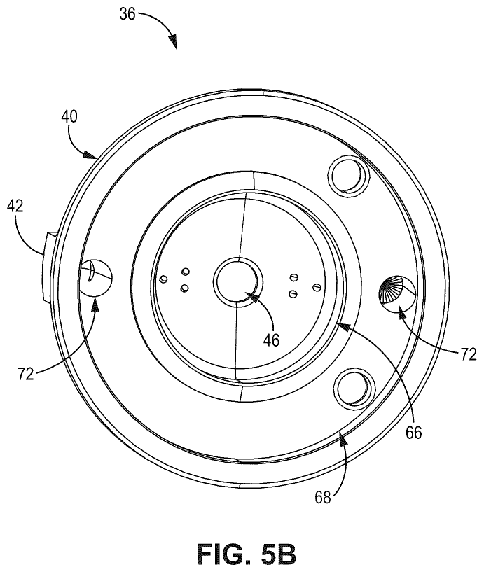

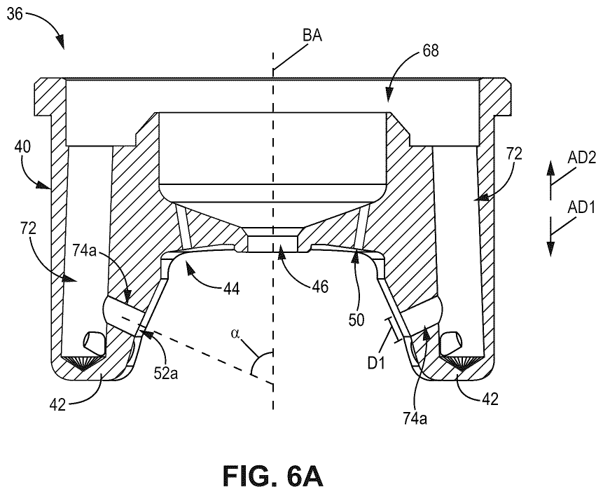

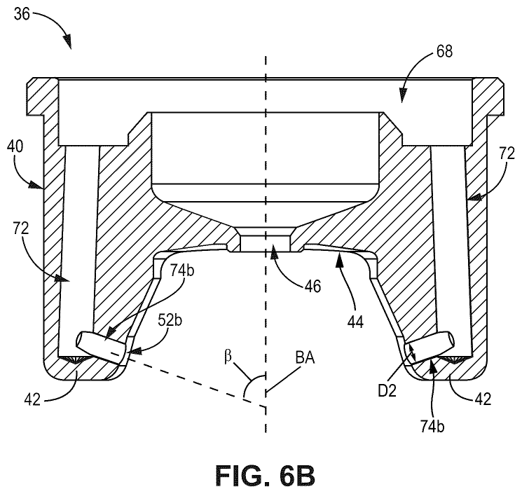

FIG. 5A is a first isometric view of air cap 36. FIG. 5B is a second isometric view of air cap 36. FIG. 6A is a cross-sectional view taken along line A-A in FIG. 5A. FIG. 6B is a cross-sectional view taken along line B-B in FIG. 5A. FIGS. 5A-6B are discussed together.

Air cap 36 includes cap body 40 having outer side 44 and prongs 42. Central aperture 46 is formed through cap body 40. Body axis BA extends through central aperture 46. Spray fluid is emitted through central aperture 46. The spray fluid is emitted from a nozzle 28 that can be at least partially disposed in central aperture 46. Central aperture 46 extends through cap body 40 such that central aperture 46 is open in both axial directions AD1, AD2 along the body axis BA. The body axis BA can be disposed coaxially with the spray axis SA with the air cap 36 mounted to a spray gun.

As discussed above, the atomization opening 48 through which atomization air is emitted from air cap 36 is formed within central aperture 46. The atomization opening 48 can be formed as an annular ring. The portion of air cap 36 defining central aperture 46 can also define a radially outer side of the annular ring forming atomization opening 48. The atomization opening 48 can be further defined on an inner radial side by a body of the nozzle assembly 58 of the spray gun.

Face ports 50 are open through outer side 44. Face ports 50 are disposed on cap face 70. Face ports 50 are disposed proximate central aperture 46. Face ports 50 are disposed radially outward of central aperture 46 and radially inward of prongs 42 relative to body axis BA. In the example shown, face ports 50 are disposed in two ports sets on opposite radial side of central aperture 46 relative to spray axis SA. Face ports 50 on air cap 36 are for cleanliness. Face ports 50 are configured to output flows of compressed gas that blow spray fluid away from cap body 40 to prevent the atomized particles from impacting and sticking to air cap 36. It is understood that air cap 36 can include more, fewer, larger, or smaller face ports 50 in the same or different positions.

Fan ports 52 are formed through prongs 42. Fan ports 52 are spaced axially from central aperture 46 in a direction downstream AD1 from central aperture 46 along body axis BA. In the example shown, each prong 42 includes a plurality of the fan ports 52. Inner fan ports 52a are disposed axially closer to central aperture 46 than outer fan ports 52b. Outer fan ports 52b are disposed axially further from central aperture 46 than inner fan ports 52a. Outer fan ports 52b are disposed closer to the distal end of the prong 42 than the inner fan port 52a of the same prong 42. In some examples, the prongs 42 can be formed as mirror images of each other. The prongs 42 are disposed on opposite sides of a spray plane SP along which the spray pattern can be elongated or shortened, such as by adjusting the flow of compressed gas to fan ports 52.

The outer fan ports 52b of the same prong 42 are disposed on opposite sides of a body plane BP that extends along the body axis BA and through the inner fan ports 52a of the prongs 42. The spray plane SP can be disposed orthogonal to the body plane PP. In the example shown, there are three fan ports 52 on each prong 42 with two outer ports 24b above a single inner port 24a. In the example shown, the inner port 24a is larger than either one of the outer fan ports 52b. The outer fan ports 52b are offset from the axis BA. The outer fan ports 52b are axially spaced from and circumferentially offset from the inner fan port 52a of the same prong 42. The outer fan ports 52b being spaced circumferentially from inner fan port 52a spreads the outputs of the shaping air further outward relative to axis BA. Such spreading assists in forming a wide pattern while preventing splitting of the pattern. In some examples, the multiple fan ports 52 on each prong 42 can be configured to impinge at three different locations of the pattern. For example, a first impingement location can be disposed along the spray axis SA and two additional impingement locations can be offset from the axis SA to further spread the atomized particles, creating a wider pattern.

Supply passages 72 are formed in cap body 40 and are disposed at least partially within each prong 42. The supply passages 72 are open in axial direction AD2. Supply passages 72 are configured to provide compressed gas to fan ports 52. Both supply passages 72 are fluidly connected to the shaping chamber 68 to receive compressed gas from the shaping chamber 68. In the example shown, all fan ports 52 of a common prong 42 are fluidly connected to the same supply passage 72 to receive compressed gas from that supply passage 72. In some examples, the supply passages 72 are fluidly connected to each other to be commonly supplied with compressed gas. As such, all fan ports 52 of the air cap 36 can be supplied by a common flow of compressed gas.

In the example shown, inner fan ports 52a have diameter D1 and outer fan ports 52b have diameter D2. Diameter D1 can be larger than diameter D2. For example, inner fan ports 52a can have a diameter D1 of about 1.702 millimeters (mm) (about 0.067 inches (in.)) and outer fan ports 52b can have a diameter D2 of about 1.473 mm (about 0.058 in.). In some examples, the inner fan port 52a can have a larger area than the outer fan port 52b. For example, the inner fan port 52 can have an area of 0.007 square inches (in²) and outer fan ports 52b can have an area of about 0.005 in².

In the example shown, each outer fan port 52b is smaller than the inner fan port 52a of the same prong 42. The combined flow area of the outer fan ports 52b is greater than the flow area of the inner fan port 52a of the same prong 42. For example, the combined flow area of the outer fan ports 52b can be about 0.010 in² while the flow area of the single inner fan port 52a can be about 0.007 in². As such, the multiple outer fan ports 52b can be configured to output compressed gas at a greater flow rate than the inner fan port 52a.

In some examples, the air cap 36 is configured such that the atomization opening 48 has a larger flow area than any one of the fan ports 52. For example, the area of the atomization opening 48 can be about 0.008 in². The area of the atomization opening 48 is less than the combined area of the pair of outer fan ports 52b on a single prong 42. The area of the atomization opening 48 is less than the combined area of the multiple fan ports 52 of a single prong 42. Each of inner fan ports 52a, outer fan ports 52b, and atomization opening 48 have larger areas than any face port 50. Each of inner fan ports 52a and outer fan ports 52b has a larger diameter than any face port 50.

Inner fan ports 52a and outer fan ports 52b provide openings through which shaping air can be emitted from air cap 36. Inner fan ports 52a are configured to direct outputs of compressed gas towards the spray fluid emitted from the nozzle 28. The inner fan ports 52a are oriented towards each other. The inner fan ports 52 can be disposed directly across from each other such that a line orthogonal to the spray plane SP extends through each of the opposed inner fan port 52a. The inner fan ports 52 can be disposed directly across from each other such that a plane (e.g., body plane BP) extends through each of the opposed inner fan ports 52a. In the example shown, the inner fan ports 52a are disposed directly across from each other such that a line extending orthogonal to the body axis BA can pass through both inner fan ports 52a.

Inner fan ports 52a are formed on the exterior of air cap 36 and output a portion of the shaping air. Inner fan passages 74a are formed within prong 42 and provide a flowpath for compressed gas to flow from within cap body 40 to inner fan ports 52a. Inner fan passages 74a are oriented to output compressed gas flow inward towards the spray axis SA and spray plane SP. Inner fan passages 74a are further oriented to output the compressed gas flow in the axially downstream direction AD1.

The opposed inner fan ports 52a form an opposed pair of fan ports 52. The opposed pair formed by inner fan ports 52a are configured to output flows of the compressed gas towards a common focal point P1. The focal point P1 is disposed at a first location along the body axis BA and is spaced axially outwards in the downstream direction AD1 from central aperture 46. The focal point P1 is spaced axially outwards in the downstream direction AD1 from either inner fan port 52a. In the example shown, the focal point P1 is disposed along the spray axis SA and on the spray axis SA.

Outer fan ports 52b are formed on the exterior of air cap 36 and output a portion of the shaping air. Outer fan passages 74b are formed within prong 42 and provide flowpaths for compressed gas to flow from within cap body 40 to an outer fan port 52b. Outer fan passages 74b are oriented to output compressed gas flow inward towards the spray plane SP. Outer fan passages 74b are further oriented to output the compressed gas flow in the axially downstream direction AD1. In some examples, the outer fan passages 74b are configured to output flow towards the spray plane SP but not towards the body plane BP. In some examples, the outer fan passages 74b extend parallel to the spray plane PA. Air cap 36 can be configured such that the output from each outer fan port 52b does not cross the body plane BP.

Inner fan passages 74a and outer fan passages 74 are sloped such that the shaping air output from air cap 36 is directed both inward towards the spray plane SP and axially downstream. In the example shown, the inner fan passages 74a are disposed at angle α. The inner fan passages 74a are sloped at angle α to direct outflows of compressed gas inwards towards the spray fluid and axially in a downstream direction. In the example shown, the outer fan passages 74b are disposed at angle β. The outer fan passages 74a are sloped at angle β to direct outflows of compressed gas inwards towards the spray fluid and axially in a downstream direction. Angle α can be less than angle β. For example, angle α can be about 63-68 degrees. In one example, angle α can be about 65-66 degrees. In one example, angle α can be about 65.6 degrees. For example, angle β can be about 69-74 degrees. In one example, angle β can be about 71-72 degrees. In one example, angle β can be about 71.7 degrees.

Angle β can be steeper than angle α such that the outflows from the outer fan ports 52b have less of an axial component than the outflows from the inner fan ports 52a. The outflows from the outer fan ports 52b can be oriented more directly towards the spray plane SP due to the steeper angle β. The outflows from the inner fan ports 52a and the outer fan ports 52b converge as the outflows move towards the spray plane SP. In the example shown, while the outflows from the inner fan ports 52a and the outer fan ports 52b converge axially, the outflows do not cross over each other. It is understood, however, that in some examples the inner fan passages 74a and outer fan passages 74b can be configured such that the outflows do cross over each other.

In some examples, the output angles α, β of fan ports 52a, 24b can be varied. For example, the fan ports 52 can be configured such that the outputs of the inner fan port 52a cross over the outputs of the outer fan ports 52b prior to interacting with the spray fluid. In such an example, the axial location that the inner fan ports 52a are oriented towards can be axially further from the central aperture 46 than the axial location that the outer fan ports 52b are oriented towards. The focal point of the inner fan ports 52a can be axially further from the central aperture 46 than the focal point of one or more outer fan ports 52b. Such a configuration can create a less wide and thicker pattern.

The outer fan ports 52b on the opposite prongs 42 can form one or more sets of opposed port pairs. In some examples, the outer fan ports 52b can be disposed in opposed pairs, each opposed pair including an outer fan port 52b from each prong 42. In the example shown, the outer fan ports 52b that are directly across from each other on the opposite prongs 42 form opposed pairs. An opposed pair of outer fan ports 52b can be best seen in FIG. 6B.

The outer fan ports 52a of an opposed pair can be disposed directly across from each other such that a line orthogonal to the spray plane SP extends through each of the opposed outer fan ports 52b of that opposed pair. The outer fan ports 52b of an opposed pair can be disposed directly across from each other such that a plane extends through each of the opposed outer fan ports 52b of the opposed pair. In the example shown, the outer fan ports 52b of an opposed pair are disposed directly across from each other and are offset above and below the body axis BA. The outer fan ports 52b are disposed radially outward from the body axis BA but are not aligned with the axis BA. Instead, the outer fan ports 52b are offset from, above and below, the body axis BA.

In some examples, the outer fan ports 52b forming an opposed pair are configured to output flows of the compressed gas towards a common axial location. The common axial location is disposed along the body axis BA and can be radially offset from the body axis BA. The common axial location is spaced axially outwards in the downstream direction AD1 from central aperture 46. The common axial location is spaced axially outwards in the downstream direction AD1 from either outer fan port 52b of the opposed pair. In some examples, the outer fan ports 52b forming an opposed pair can be oriented to output flows of compressed gas towards a common focal point, as discussed in more detail below.

The outer fan ports 52b can be configured such that the focal point for each opposed pair of outer fan ports 52b differs from the focal points of other pairs of outer fan ports 52b. For example, the focal point of a first opposed pair of outer fan ports 52b can be spaced radially from the focal point of a second opposed pair of outer fan ports 52b. The focal points of the first and second opposed pair of outer fan ports 52b can be at the same axial location along the body axis BA but with the two focal points radially offset from each other at that common axial location.

It is understood that, in some examples, additional fan ports 52 can be added in one or more rows with those shown, such as for a total of three, four, or more arrays of fan ports 52 on a single prong 42. In some examples, additional rows of fan ports 52 can be added above the top holes shown (e.g., on an opposite side of outer fan ports 52b from the inner fan ports 52a). Additional rows of outer fan ports 52b can be added to further increase pattern width.

Air cap 36 is configured to create a larger spray pattern than traditional air caps for low pressure sprayers. Traditional air caps include fan holes on the prongs aligned on the body axis BA and aligned along the prong 42, not offset. Air cap 36 is configured to generate a spray pattern that has a width up to 100% wider than a traditional air cap. For example, air cap 36 can create a spray pattern ranging from 3 in (0% fan air) to 24 in (100% fan air) at fluid flow rate of about 600 cubic centimeters (ccm) and about 35 PSI air pressure from 10 in away from substrate using the same or similar air volume as a traditional air spray air cap. The traditional air cap can typically create a maximum width of 12-16 in. in the same conditions. Traditional air caps all impinge along the spray axis SA but do not output offset from the spray axis. This limits the pattern size and makes the pattern susceptible to splitting.

Many air spray users paint extremely large items. For example, a single firetruck can require the equivalent of five billboards of paint. The limit for an air spray gun is generally considered around 300 ccm. Air cap 36 can atomize up to twice what is considered normal, allowing the task to be completed up to two times faster. Roughly the same volume of air is used to create the wide pattern, and, the pattern doesn't split. The wide pattern from air cap 36 allows an end user to exert far less effort when painting. Air cap 36 can thereby provide for faster, more efficient application of spray fluid onto a substrate while utilizing the same volume of compressed gas, reducing job time without increasing compressed gas cost.

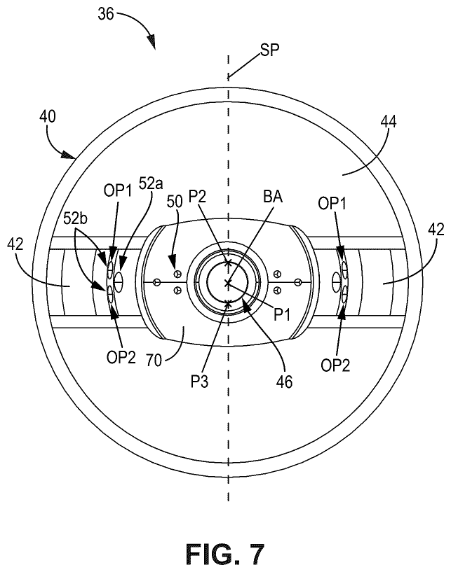

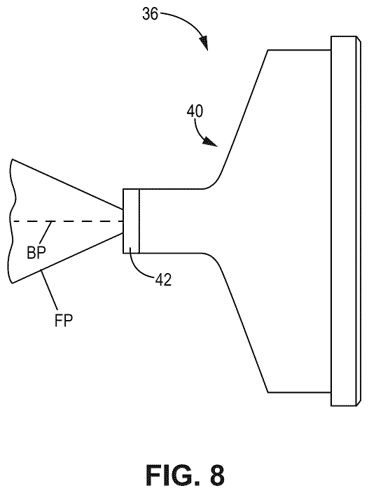

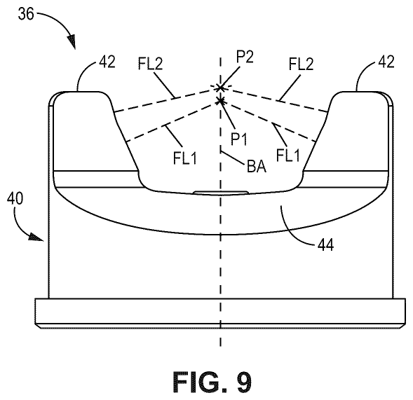

FIG. 7 is a front elevational view of air cap 36. FIG. 8 is a side view of air cap 36 showing a spray pattern FP. FIG. 9 is a top view of air cap 36 showing shaping air outputs. FIGS. 7-9 are discussed together and with continued reference to FIGS. 1-6B. Air cap 36 is configured to output flows of compressed gas from fan ports 52 to shape the spray fluid output by a spray gun. Air cap 36 outputs flows of compressed gas through fan ports 52 to shape the spray fluid into a spray pattern having desired width and other characteristics.

Inner fan ports 52a and outer fan ports 52b are formed through each prong 42. In the example shown, the fan ports 52 are disposed in opposed pairs that are disposed across the spray plane SP from each other. The inner fan ports 52a form an inner opposed pair. A first pair of the outer fan ports 52b (indicated by reference OP1) forms a first outer opposed pair and a second pair of outer fan ports 52b (indicated by reference OP2) forms a second outer opposed pair.

In the example shown, each fan port 52 of an opposed pair is configured to direct its compressed gas output towards a common focal point with the other fan port 52 of that opposed pair. In the example shown, the inner opposed pair is configured to direct flows towards focal point P1. The outputs from the inner opposed pair is shown as flow line FL1 in FIG. 9. Focal point P1 is spaced axially outwards from central aperture 46. As best seen in FIG. 7, the focal point P1 is disposed on the spray plane SP. As best seen in FIG. 7 the focal point P1 is disposed on the spray axis SA.

In the example shown, the first outer opposed pair is configured to direct flows towards focal point P2. In the example shown, the second outer opposed pair is configured to direct flows towards focal point P3. Focal points P2, P3 can be disposed at the same axial distance from central aperture 46 such that focal points P2, P3 are at a same axial location or distance along the body axis BA. In the example shown, focal points P2, P3 are radially offset from the body axis BA and from each other relative to body axis BA, as best seen in FIG. 7. Focal point P2 is disposed on one side of the body plane BP and focal point P3 is disposed on an opposite side of the body plane BP. The outputs from the first opposed pair of outer fan ports 52b is shown as flow line FL2 in FIG. 9.

The offset configuration of the fan ports 52 facilitates formation of a wide spray pattern. The outputs from inner fan ports 52a is aimed towards the spray axis SA to impinge on the atomized spray fluid. The outputs from the inner fan ports 52a encourages widening of the pattern. The outputs of the outer fan ports 52b are offset from the outputs from the inner fan ports 52a. The outputs of the outer fan ports 52b impinge on the spray fluid at locations radially outward of focal point P1, further widening the pattern by the outputs from the outer fan ports 52b. In the example shown, the outputs from the outer fan ports 52b are aimed further downstream than the outputs from the inner fan ports 52a, further facilitating widening of the pattern by the outputs through fan ports 52.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. An air cap for a spray gun, the air cap configured to output compressed gas onto a spray fluid, the air cap comprising:
a cap body having a central aperture therethrough, the central aperture disposed on a body axis of the cap body, the cap body further including a plurality of prongs extending from an outer side of the cap body;
a plurality of face ports formed through the outer side;
a first set of fan ports formed through an inner exterior side of a first prong of the plurality of prongs, the first set of fan ports including:
a first inner fan port; and
a first plurality of outer fan ports, the first plurality of outer fan ports disposed axially closer to a distal end of the first prong than the first inner fan port; and
a second set of fan ports formed through an inner exterior side of a second prong of the plurality of prongs, the second set of fan ports including:
a second inner fan port; and
a second plurality of outer fan ports, the second plurality of outer fan ports disposed axially closer to a distal end of the second prong than the second inner fan port.

2. The air cap of claim 1, wherein each outer fan port of the first plurality of outer fan ports is spaced outward from a spray plane extending along the body axis and through the first inner fan port and the second inner fan port.

3. The air cap of claim 2, wherein the first plurality of outer fan ports includes a first outer fan port disposed on a first side of the spray plane and a second outer fan port disposed on a second side of the spray plane.

4. The air cap of claim 2, wherein the spray plane bisects the first plurality of outer fan ports and the second plurality of outer fan ports.

5. The air cap of claim 1, wherein the first inner fan port has a larger area than any face port of the plurality of face ports.

6. The air cap of claim 5, wherein each outer fan port of the first plurality of outer fan ports has a larger area than any face port of the plurality of face ports.

7. The air cap of claim 1, wherein at least one outer fan port of the first plurality of outer fan ports has a smaller area than the first inner port.

8. The air cap of claim 7, wherein each outer fan port of the first plurality of outer fan ports has a smaller area than the first inner port.

9. The air cap of claim 8, wherein a total combined area of the first plurality of outer fan ports is greater than an area of the first inner fan port.

10. The air cap of claim 1, wherein the first inner fan port is oriented to direct a first inner gas flow towards a first axial location spaced axially from the central aperture, and the second inner fan port is oriented to direct a second inner gas flow towards the first axial location.

11. The air cap of claim 10, wherein the first axial location is disposed on the spray axis.

12. The air cap of claim 10, wherein the first plurality of outer fan ports and the second plurality of outer fan ports are oriented to output respective outer gas flows towards a second axial location disposed axially further from the central aperture than the first location.

13. The air cap of claim 12, wherein each outer fan port of the first plurality of outer fan ports is oriented to output the respective outer gas flows towards different focal points.

14. An air cap for a spray gun, the air cap configured to output compressed gas onto a spray fluid, the air cap comprising:
a cap body having a central aperture therethrough, the central aperture disposed on a body axis of the cap body, the cap body further including a plurality of prongs extending from an outer side of the cap body;
a plurality of face ports formed through the outer side;
a first set of fan ports formed through an inner exterior side of a first prong of the plurality of prongs, the first set of fan ports including:
a first inner fan port;
a first outer fan port disposed axially closer to a distal end of the first prong than the first inner fan port, the first outer fan port circumferentially offset from the first inner fan port; and
a second outer fan port disposed axially closer to the distal end of the first prong than the first inner fan port, the second outer fan port circumferentially offset from the first inner fan port; and
a second set of fan ports formed through an inner exterior side of a second prong of the plurality of prongs, the second set of fan ports including:
a second inner fan port;
a third outer fan port disposed axially closer to a distal end of the second prong than the second inner fan port, the third outer fan port circumferentially offset from the second inner fan port; and
a fourth outer fan port disposed axially closer to the distal end of the second prong than the second inner fan port, the fourth outer fan port circumferentially offset from the second inner fan port.

15. The air cap of claim 14, wherein:
the first inner fan port, the first outer fan port, and the second outer fan port are fluidly connected to a first supply passage within the cap body to receive compressed gas from the first supply passage; and
the second inner fan port, the third outer fan port, and the fourth outer fan port are fluidly connected to a second supply passage within the cap body to receive compressed gas from the second supply passage.

16. The air cap of claim 14, wherein:
the first inner fan port and the second inner fan port are oriented to direct the compressed gas towards a first focal point disposed on the body axis;
the first outer fan port and the third outer fan port are oriented to direct the compressed gas towards a second focal point; and
the second focal point is disposed axially further from the central aperture than the first focal point.

17. The air cap of claim 16, wherein the second focal point is radially offset from the body axis.

18. The air cap of any claim 16, wherein the second outer fan port and the fourth outer fan port are oriented to direct the compressed gas towards a third focal point, the third focal point is disposed axially further from the central aperture than the first focal point, and the third focal point is radially offset from the body axis.

19. The air cap of claim 18, wherein the second focal point and the third focal point are disposed on opposite sides of a spray plane extending along the body axis and through the first inner fan port and the second inner fan port.

20. A spray gun comprising:
a gun body;
a nozzle formed in a nozzle body, the nozzle body at least partially disposed within the gun body, the nozzle configured to output spray fluid along a spray axis;
a valve configured to control flow of the spray fluid through the nozzle; and
an air cap mounted to the gun body, the air cap comprising:
a cap body having a central aperture therethrough, the central aperture disposed on a body axis of the cap body, the cap body further including a plurality of prongs extending from an outer side of the cap body, wherein the nozzle body extends into the central aperture;
a plurality of face ports formed through the outer side;
a first set of fan ports formed through an inner exterior side of a first prong of the plurality of prongs, the first set of fan ports including:
a first inner fan port;
a first outer fan port disposed axially closer to a distal end of the first prong than the first inner fan port, the first outer fan port circumferentially offset from the first inner fan port; and
a second outer fan port disposed axially closer to the distal end of the first prong than the first inner fan port, the second outer fan port circumferentially offset from the first inner fan port; and
a second set of fan ports formed through an inner exterior side of a second prong of the plurality of prongs, the second set of fan ports including:
a second inner fan port;
a third outer fan port disposed axially closer to a distal end of the second prong than the second inner fan port, the third outer fan port circumferentially offset from the second inner fan port; and
a fourth outer fan port disposed axially closer to the distal end of the second prong than the second inner fan port, the fourth outer fan port circumferentially offset from the second inner fan port;
wherein the air cap is configured to output an atomizing compressed gas flow through an atomization opening disposed between the nozzle body and a portion of the cap body defining the central aperture; and
wherein the air cap is configured to output a shaping compressed gas flow through the first set of fan port and the second set of fan ports.
